(19) United States
(12) Patent Application Publication
(10) Pub. No.: US 2009/0286506 A1
(43) Pub. Date: Nov. 19, 2009

(54) Fixed Mobile Convergent Service in Enterprise Environments

(75) Inventors: Chris Yonghai Gu, Westminster, CO (US); Shane M. Amante, Denver, CO (US)

Correspondence Address: DAMON A. RIETH, 300 CENTER DRIVE , SUITE G #116, SUPERIOR, CO, 80027, US

(73) Assignee: Level 3 Communications, LLC, Broomfield, CO (US)

(21) Appl. No.: 12/408,680

(22) Filed: Mar. 21, 2009

Related U.S. Application Data
(60) Provisional application No. 61/053,586, filed on May 15, 2008.

(51) Int. Cl. H04M 11/00; H04M 3/00

(52) U.S. Cl. 455/406; 455/426.1

(57) ABSTRACT

A method for communicating in an enterprise network includes determining that a mobile device generating a communication request has an assigned enterprise voice number; and based in part on determining that the mobile device has an assigned enterprise voice number, establishing the requested communication over the enterprise network. A system for communicating over an enterprise network includes an enterprise voice number registry that maps enterprise voice numbers to mobile devices registered on the enterprise network, and an enterprise mobile switching center operable to query the enterprise voice number registry to determine if a mobile device is registered and further operable to determine that a communication requested by the mobile device should be established over the enterprise network based on the determination that the mobile device is registered. The enterprise network may be managed by the enterprise operator to satisfy enterprise network users.

### CROSS REFERENCE TO RELATED APPLICATIONS

This application claims the benefit of priority to U.S. Provisional Patent Application 61/053,586, filed May 15, 2008, titled “Fixed Mobile Convergent Service In Enterprise Environments”, which is incorporated herein by reference for all purposes.

### COPYRIGHT NOTICE

Contained herein is material that is subject to copyright protection. The copyright owner has no objection to the facsimile reproduction of the patent disclosure by any person as it appears in the Patent and Trademark Office files or records, but otherwise reserves all rights to the copyright whatsoever. Copyright© 2009 Level 3 Communications, LLC.

### TECHNICAL FIELD

Embodiments presently disclosed generally relate to voice communications and services. More specifically, embodiments herein relate to providing mobile voice services across an enterprise network.

### BACKGROUND

Communication device users often have multiple communication devices that have various differences, depending on their purpose. For example, an office worker often has a work phone at his office and a mobile phone he carries with him. Among other differences, the worker typically pays the bill for the mobile phone service, while the worker's employer is responsible for the fees associated with the office phone service. In addition, each communication device is assigned a unique telephone number. The varying uses, billing arrangements, phone numbers and locations of a user's communication devices can give rise to various inconveniences related to multiple devices.

For example, users would like a mobile device with the ability to use it for different purposes, but would like mobile device bills to be apportioned correctly among the personal uses and other uses, or at least have non-personal minutes not applied to the personal mobile phone bill. To illustrate, workers often give out their personal mobile phone numbers to co-workers, clients or other business contacts out of business necessity, courtesy or expediency. In this case, the worker generally will not want to be billed for minutes spent in work-related conversations on the mobile phone.

As another example, employers and workers would like a relatively seamless extension of the office with the use of communication devices. For example, a worker would like the ability to easily transfer work related calls from the office phone to the mobile phone and vice versa. This ability would be useful in cases where a business call begins on the office phone, but the worker needs to leave the office, or in the opposite scenario, when the call starts on the mobile device, for example outside the office, and the user would like to transfer the call to the office phone when he arrives in his office.

Businesses in today's global economy can have multiple offices often located at different physical locations. Such businesses typically require conventional enterprise networks for voice and data services that enable their employees to freely and securely exchange information and communicate with one another. For example, a conventional enterprise network for voice services may include a Private Branch eXchange “PBX”, while a conventional enterprise network for data services may include a Local Area Network “LAN” or a Wide Area Network “WAN”.

### SUMMARY

Embodiments presently disclosed generally relate to voice communications and services. More specifically, embodiments herein relate to managing and administering mobile services for enterprise networks in conjunction with underlying mobile carrier networks. For instance, one example embodiment relates to a method for interfacing with an enterprise voice number of a mobile device (e.g., company number) while the mobile device is proximately located on company premises (i.e., the enterprise network being associated with the company). Another example embodiment relates to a method for interfacing with a non-enterprise voice number of a mobile device (e.g., personal cellular phone number) while the mobile device is not proximately located on company premises.

An embodiment of a method for communicating in an enterprise network includes determining that a mobile device generating a communication request has an assigned enterprise voice number, and based in part on determining that the mobile device has an assigned enterprise voice number, establishing the requested communication over the enterprise network. Establishing the requested communication over the enterprise network may include bypassing a mobile service provider network associated with the mobile device. The method may further include receiving the communication request proximate to an enterprise site. Receiving the communication request may include intercepting the communication request at a wireless base station at the enterprise site.

Still further, the method may include receiving the communication request from a backbone network. Determining that the mobile device has an assigned enterprise voice number may include querying a database of enterprise voice numbers assigned to mobile devices. The method may further include assigning the enterprise voice number to the mobile device. The method may further include validating that the mobile device has a mobile phone number issued by an associated mobile service provider. In various embodiments of the method, establishing the requested communication over the enterprise network causes service charges associated with the requested communication to be attributed to the enterprise network rather than the mobile service provider network associated with the mobile device.

An embodiment of a system for communicating over an enterprise network includes an enterprise voice number registry that maps enterprise voice numbers to mobile devices registered on the enterprise network, and an enterprise mobile switching center operable to query the enterprise voice number registry to determine if a mobile device is registered and further operable to determine that a communication requested by the mobile device should be established over the enterprise network based on the determination that the mobile device is registered. The system may further include a location registry operable to monitor the location of the mobile device in the enterprise.

In various embodiments of the system the enterprise mobile switching center is further operable to validate that a mobile device has a mobile phone number issued by an associated mobile service provider. The system may further include a remotely accessible interface operable to provide access to the enterprise voice number registry. The system may further include an enterprise media gateway in communication with an enterprise switch to enable communications between the enterprise switch and one or more of the Internet, a public landline mobile network and a public switched telephone network. The system may still further include a base station controller in communication with the enterprise media gateway to manage wireless enterprise base stations operable to handle communications to and from registered mobile devices. In various embodiments of the system establishing the requested communication over the enterprise network causes service charges associated with the requested communication to be attributed to the enterprise network.

An embodiment of a computer program product having a computer-readable media storing computer-executable instructions causes a computer to carry out a process. The process may include receiving a request to initiate a voice communication over an enterprise network to a first enterprise voice number assigned to a mobile device, the request initiated by a telecommunications device associated with the enterprise network, the telecommunications device having a second enterprise voice number assigned thereto, determining that the request originates from the second enterprise voice number, and initiating the voice communication from the second enterprise voice number to the first enterprise voice number across the enterprise network, wherein service charges associated with the mobile device for the voice communication are attributable to the enterprise network.

The process may further include assigning the first enterprise voice number to the mobile device. The process may still further include checking a registry of a public landline mobile network to validate a mobile phone number of the mobile device prior to assigning the first enterprise voice number to the mobile device. Further still, the process may include monitoring the location of the mobile device within the enterprise network.

### BRIEF DESCRIPTION OF THE DRAWINGS

FIG. 1 illustrates an example network environment suitable for managing mobile voice service over an enterprise network.

FIG. 2 illustrates an example enterprise fixed mobile convergent (EFMC) network architecture.

FIGS. 3-6 are flowcharts illustrating example processes for managing mobile voice service over an enterprise network according to one or more embodiments.

FIG. 7 is an example block diagram of a computer system configured with an enterprise manager application and process according to embodiments herein.

### DETAILED DESCRIPTION

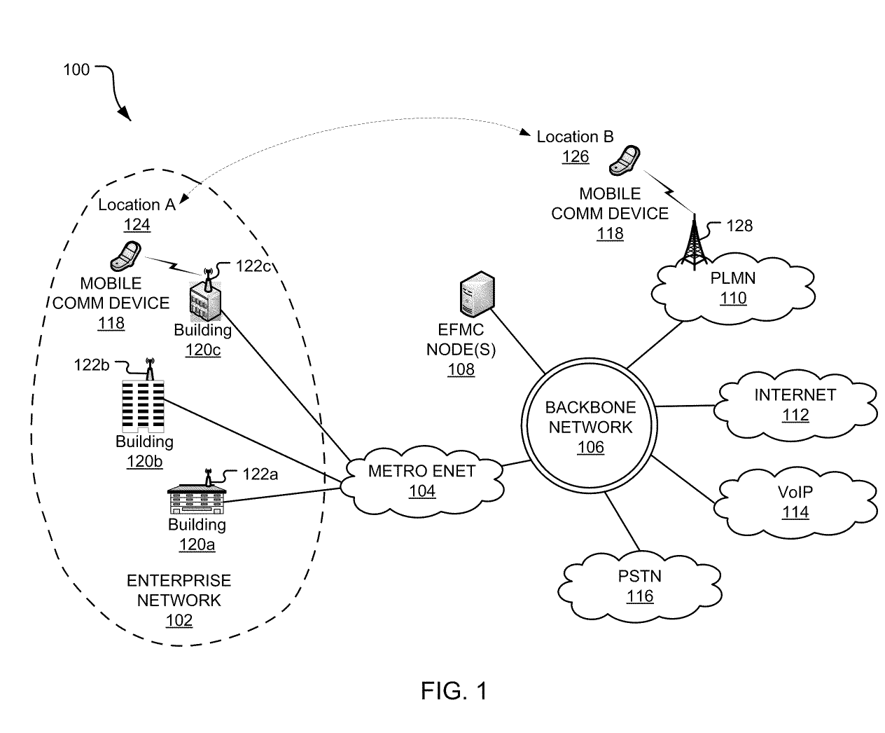

FIG. 1 illustrates an example network environment 100 suitable for managing mobile voice service over an enterprise network 102. The network environment 100 includes an enterprise region 102 (indicated by the dotted line) in communication with a metro data network 104 (e.g., Metro ENET). The metro data network 106 is in communication with a backbone network 106. In one embodiment, the backbone network 106 is a fiber backbone network. Backbone network 106 communicatively couples enterprise network 102 and metro data network 104 to one or more other networks or network nodes.

For example, in the illustrated embodiment, backbone network 106 is in further communication with one or more Enterprise Fixed Mobile Convergence (EFMC) nodes 108, a Public Land Mobile Network (PLMN) 110, the Internet 112, a Voice over Internet Protocol (VoIP) network 114, and a Public Switched Telephone Network (PSTN) 116.

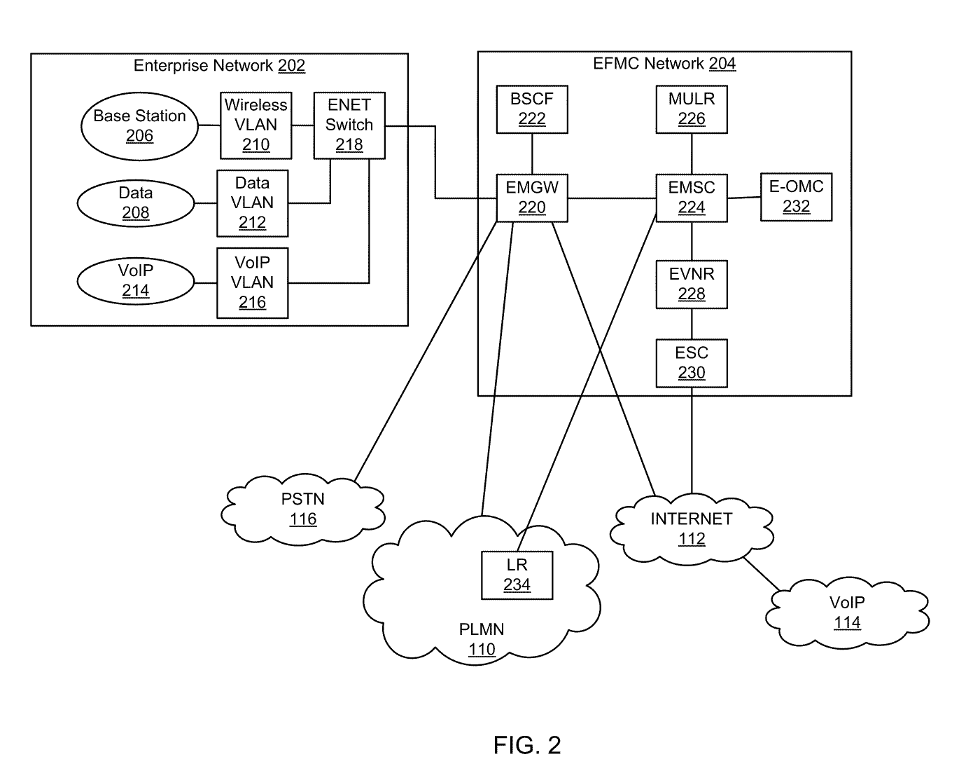

EFMC node 108 may be implemented in one or more server computers or other general-purpose or special-purpose computing devices, which may be housed in a telecommunications center or other building. Those servers can also be distributed in different physical locations connected via a high speed data network. EFMC node 108 may be provided by an EFMC service provider. EFMC node 108 may be a component in a larger EFMC network. An example EFMC network 204 is illustrated in FIG. 2 and discussed further below. EFMC node 108 generally provides services related to fixed mobile convergence (FMC) for use in an enterprise environment, and is described in further detail below. PLMN 110 is associated with, and may provide communication service to, one or more mobile device users who subscribe to service over the PLMN 110. One or more of these subscribing mobile device users may also be associated with the enterprise network 102. For example, a mobile device user may be an employee of the enterprise responsible for the enterprise network 102.

From the PLMN 110 operator's point of view, it is often preferred to have voice traffic generated inside an office environment over its wireless spectrum go through the enterprise network of the office environment directly, to offload the traffic from its wireless access network and save its mobile backhaul network cost/bandwidth.

The PLMN 110 operator also often prefers the voice traffic generated inside the office environment over its wireless spectrum stays inside the office environment without taking resources from the cell site outside the office environment, and, consequently, leave the network capacity of cell sites outside the office to real mobile users outside, delay the investment on network capacity expansion and improve its business model (cash flow).

In at least one embodiment, EFMC node 108 is configured to provide FMC-related functions to an enterprise user who uses a mobile communication device 118 (e.g., cell phone, PDA “Personal Data Assistant”, smart phone, etc.) in the proximity of the enterprise network 102. A mobile device user may also use one or more other devices, such as an enterprise-based communication device (e.g., an office telephone) (not shown). Generally, the mobile device 118 has an assigned mobile voice number associated with a mobile carrier network (e.g., AT&T®). According to various embodiments, the mobile device 118 is assigned an enterprise voice number (e.g., work phone number having, for example, an extension number associated thereto, like the enterprise desk phone does).

In accordance with some embodiments, when the mobile device 118 is proximately located near an enterprise entity 120, the mobile device sends and receives voice calls via the enterprise voice number. Proximately located near an enterprise entity 120 generally means within communication range of an enterprise-based cellular transponder, such as a wireless base station 122 inside an office building. In accordance with one or more embodiments, wireless base station 122 is configured to determine that the mobile device 118 has an assigned enterprise voice number, causing calls from the mobile device 118 to be established over the enterprise network 102. For example, when mobile device 118 is proximately located at location A 124 near wireless base station 122 of office building 120c, the assigned enterprise voice number may be used for communication. By establishing calls from the mobile device 118 over the enterprise network 102, the mobile carrier network 110, which would otherwise carry the calls, can be bypassed.

With further regard to the wireless base stations 122, according to an embodiment, wireless base stations 122 include one or more picocells, microcells and/or femtocells operable to intercept outgoing communications from the mobile device 118 and direct incoming enterprise calls to the mobile device 118. Although the wireless base stations 122 are depicted outside the buildings 120 in FIG. 1, one or more of the picocells, microcells and/or femtocells 122 are typically installed inside enterprise site buildings 120. Alternatively, or in addition, one or more base stations 122 could be mounted on structures outside enterprise site buildings 120, such as on light poles. Picocells, microcells and/or femtocells generally have ranges of operation typically ranging from tens to thousands of feet, and can be selected based at least in part on the desired operational range.

On the other hand, when the mobile device 118 is not proximately located at one of the enterprise entities 120, the mobile device sends and receives voice calls via its mobile number. In such a case, the voice call traverses the PLMN 110. For example, when mobile device 118 is at location B 126, mobile device 118 may communicate via a cell tower 128 through PLMN 110 using its carrier assigned mobile number.

The display on the mobile device 118 indicates which network the mobile device 118 camps on so that the user of the mobile device 118 can be aware of its mobile operation environment, apply different dialing plans accordingly, e.g. dial an extension number directly to reach another enterprise user as does the desk phone when the mobile is camped on the EFMC network, or dial a given digit first, e.g. number 9, to access “external” lines.

According to various embodiments, when the mobile device 118 initiates a voice call using the enterprise voice number (i.e., when the mobile device is located proximate to an enterprise base station 122), the call is routed through the EFMC node 108 for further handling. The EFMC node 108 may, for instance, determine how the voice call should be routed through the enterprise network 102 and/or the Metro ENET 104. EFMC node 108 may also or alternatively determine how the service charges associated with the voice call should be applied.

If, for example, the voice call is directed to another phone number within the enterprise network 102, the voice call is routed through the enterprise network 102 and any service charges associated with the voice call would be attributed to the enterprise network 102. In other words, the user making the voice call with the mobile phone 118 would not incur service charges (e.g., expend minutes on his or her personal mobile voice plan), and the cost of the call would be attributed to the enterprise. Moreover, by routing the voice call through the enterprise network 102, the call avoids the mobile carrier's network (e.g., PLMN 110). Accordingly, the mobile carrier network 110 associated with the mobile device 118 is not burdened with the enterprise-related voice call.

In another embodiment, if a voice call is initiated from a telecommunications device outside of the enterprise network 102 (e.g., a call placed from a landline phone connected to the PSTN 116), and is directed to an enterprise voice number, the EFMC node 108 can intercept the extra-enterprise voice call and determine whether the enterprise voice number being called is associated with a mobile device 118. If so, the EFMC node 108 may route the call to the mobile device 118 and/or a landline (e.g., an office telephone) associated with the enterprise voice number through the enterprise network 102. If, for example, the mobile phone 118 is proximately located near an enterprise base station 122, a user of the mobile phone 118 can answer the call and would not incur service charges associated therewith (i.e., the services charges would be attributable to the enterprise).

If, for example, the mobile phone 118 is not proximately located at an enterprise base station 122, the EFMC node 108 may route the extra-enterprise call to the mobile voice number associated with the mobile device 118. As such, the call would be routed across the mobile carrier network 110 associated with the mobile device 118. Depending on the mobile enterprise policy, the expenses or service charges associated with such a call may be attributable to the mobile carrier network 110 (and thus the mobile device 118 user) or to the enterprise, or both.

Some embodiments include an enterprise manager process for managing mobile voice services over an enterprise network 102. One or more functions of the enterprise manager process may be carried out by the EFMC node 108, the wireless base stations 122, and/or other components of the network environment 100. The mobile voice services are provided, at least in part, by a mobile carrier network 110 (e.g., AT&T®) associated with the enterprise network 102. Generally, the mobile carrier network 110 service provider has already assigned a mobile voice number to a mobile device 118 (e.g., cellular phone) for interfacing with the mobile carrier network, PLMN, 110. According to one embodiment, the enterprise manager process assigns a first enterprise voice number to the mobile device 118 to enable the mobile device 118 to interface with the enterprise network 102. As a result, the enterprise manager process can then manage mobile voice services for the mobile device 118 over the enterprise network 102.

According to one example embodiment, the enterprise manager process receives a request from the mobile device 118 to initiate a voice communication over the enterprise network 102 to a second enterprise voice number associated with the enterprise network 102. The second enterprise voice number is assigned to a telecommunications device. The enterprise manager process then determines that the request originates from the first enterprise voice number. In response, the enterprise manager process initiates the voice communication from the first enterprise voice number to the second enterprise voice number across the enterprise network 102. As a result, any services charges associated with the mobile device for the voice communication are attributed to the enterprise network 102.

According to another example embodiment, the enterprise manager process receives a request from the mobile device 118 to initiate a voice communication over the enterprise network 102 to a unique voice number not associated with the enterprise network 102. The unique voice number is assigned to a telecommunications device. The enterprise manager process then determines that the request originates from the first enterprise voice number. In response, the enterprise manager process initiates the voice communication from the first enterprise voice number to the unique voice number across, at least in part, the enterprise network 102 and across, at least in part, the mobile carrier network 110. As such, any services charges associated with the mobile device 118 for the voice communication are attributed to the mobile carrier network 110.

According to yet another example embodiment, the enterprise manager process receives a request to initiate a voice communication over the enterprise network 102 to the first enterprise voice number. The request is initiated by a telecommunications device associated with the enterprise network 102. The telecommunications device has been assigned a third enterprise voice number. The enterprise manager process then determines that the request originates from the third enterprise voice number. In response, the enterprise manager process initiates the voice communication from the third enterprise voice number to the first enterprise voice number (i.e., the enterprise voice number assigned to the mobile device 118) across the enterprise network 102. As a result, any services charges associated with the mobile device 118 for the voice communication are attributed to the enterprise network 102.

In yet another example embodiment, the enterprise manager process receives a request to initiate a voice communication over the enterprise network 102 to the first enterprise voice number. The request is initiated by a telecommunications device not associated with the enterprise network 102. The telecommunications device has been assigned a unique voice number. The enterprise manager process then determines that the request originates from the unique voice number. In response, the enterprise manager process initiates the voice communication from the unique voice number to the first enterprise voice number across, at least in part, the enterprise network 102 and across, at least in part, the mobile carrier network 110. As such, any services charges associated with the mobile device 118 for the voice communication are attributed to the enterprise network 102.

In another example embodiment, the enterprise manager process receives a request from the mobile device 118 to initiate a voice communication over the enterprise network 102 to a second enterprise voice number associated with the enterprise network 102. The second enterprise voice number has already been assigned to a telecommunications device. The enterprise manager process then determines that the request originates from the mobile voice number. In response, the enterprise manager process initiates the voice communication from the mobile voice number to the second enterprise voice number across, at least in part, the mobile carrier network 110 and across, at least in part, the enterprise network 102. As a result, any services charges associated with the mobile device for the voice communication are attributed to the enterprise network 102.

According to yet another embodiment, the enterprise manager process receives a request to initiate a voice communication over the enterprise network to the first enterprise voice number. The request is initiated by a telecommunications device associated with the enterprise network 102. The telecommunications device has been assigned a third enterprise voice number. The enterprise manager process determines that the request originates from the third enterprise voice number. In response, the enterprise manager process initiates the voice communication from the third enterprise voice number to the first enterprise voice number across the enterprise network 102. As a result, any services charges associated with the mobile device for the voice communication received by the first enterprise voice number are attributed to the enterprise network 102. In this example embodiment, the enterprise manager process can also initiates the voice communication from the third enterprise voice number to the mobile voice number across, at least in part, the enterprise network 102 and across, at least in part, the mobile carrier network 110. Similarly, any services charges associated with the mobile device 118 for the voice communication received by the mobile voice number are attributed to the enterprise network 102.

In still yet another example embodiment, the enterprise manager process receives a request to initiate a voice communication over the enterprise network 102 to the first enterprise voice number. The request is initiated by a telecommunications device associated with the enterprise network 102. The telecommunications device has been assigned a third enterprise voice number. The enterprise manager process then determines that the request originates from the third enterprise voice number. In response, the enterprise manager process initiates the voice communication from the third enterprise voice number to the first enterprise voice number across the enterprise network 102. As such, any services charges associated with the mobile device for the voice communication received by the first enterprise voice number are attributed to the enterprise network 102. In the same vein, the enterprise manager process can also initiate the voice communication from the third enterprise voice number to the mobile voice number across, at least in part, the enterprise network 102 and across, at least in part, the mobile carrier network 110. In contrast, any services charges associated with the mobile device 118 for the voice communication received by the mobile voice number are attributed to the mobile carrier network 110.

According to another example embodiment, the enterprise manager process receives a request to initiate a voice communication over the enterprise network 102 to the first enterprise voice number. The request is initiated by a telecommunications device associated with the enterprise network 102. The telecommunications device has been assigned a third enterprise voice number. The enterprise manager process then determines that the request originates from the third enterprise voice number. In response, the enterprise manager process initiates the voice communication from the third enterprise voice number to the first enterprise voice number across the enterprise network 102. During such operation, the enterprise manager process can then determine that the mobile device 118 associated with the first enterprise number has not acknowledged initiation of the voice communication from the third enterprise voice number (e.g., voicemail). In response, the enterprise manager process initiates the voice communication from the third enterprise voice number to the mobile voice number across, at least in part, the enterprise network 102 and across, at least in part, the mobile carrier network 110. In one configuration, any service charges associated with the mobile device 118 for the voice communication received by the mobile voice number are attributed to the mobile carrier network 110. In another example configuration, any services charges associated with the mobile device for the voice communication received by the mobile voice number are attributed to the enterprise network 102.

FIG. 2 illustrates an enterprise network 202 in communication with an example enterprise fixed mobile convergent (EFMC) network 204 according to an embodiment. The EFMC network 204 architecture includes a number of components carrying out various functions to provide for fixed mobile convergence for the enterprise network 202. The EFMC network 204 may be composed of one or more interconnected EFMC nodes 108 shown in FIG. 1.

In the illustrated embodiment, the enterprise network 202 has a number of types and sources of enterprise media. For example, mobile phone voice media is communicated via one or more base stations 206 coupled to a wireless virtual local area network (VLAN) 210; data sources 208 (e.g., computers) are coupled to a data VLAN 212; Voice over Internet Protocol (VoIP) sources 214 are coupled to a VoIP VLAN 216. Wireless VLAN 210, data VLAN 212 and VoIP VLAN 216 are in operable communication with a switch, such as Ethernet switch 218. ENET switch 218 is in operable communication with an enterprise media gateway (EMGW) 220 of the EFMC network 204. In one embodiment, the EMGW 220 is proximate to enterprise network 202. One embodiment of the EMGW 220 includes a media gateway that provides an Ethernet interface with separated VLAN for voice, data and mobile picocell/femtocell connections.

With further regard to the EMGW 220, the EMGW is configured to interface with ENET switch 218 to provide media connections for EFMC service. The EMGW 220 is operable to interface with Public Landline Mobile Network (PLMN) 110, public switch telephone network (PSTN) 116, Internet 112 and/or VoIP network 114 for public network connection services.

In one embodiment, the EMGW 220 includes base station controller (BSC) Function 222. Alternatively, the EMGW 220 may include an interface operable to interact with an independent BSC Function (BSCF) 222 server to provide mobile handset mobility management service interface. According to an embodiment, the EMGW 220 is controlled by a softswitch for EFMC services.

In the illustrated embodiment, an enterprise mobile switch center (EMSC) 224 is included in the EFMC network 204. The EMSC 224 connects and manages EFMC network 204 components. The EMSC 224 also interfaces with public networks (e.g., PSTN 116, PLMN 110) to provide switch/routing services. The EMSC 224 is in communication with a mobile service provider location registry 234 of the PLMN 110. The PLMN LR 234 stores mobile subscriber identification information, which the EMSC 224 uses to validate mobile devices to be registered on the enterprise network 202. Among other functions of the EMSC 224, the EMSC 224 communicates mobile service subscriber information to a mobile user location registry (MULR) 226, which stores registered mobile phone location for registered mobile phones within enterprise EFMC network coverage.

In accordance with an embodiment, the MULR 226 authenticates mobile phones whose locations are to be monitored on the enterprise network 202. The MULR 226 queries an enterprise voice number registry (EVNR) 228 to authenticate mobile devices. The EVNR 228 stores registered enterprise user information and service definitions. In one embodiment, the EVNR 228 stores a mapping of mobile phone numbers of registered mobile phones to enterprise voice numbers that have been assigned to the registered mobile phones.

In various embodiments, authorized personnel (e.g., information technology (IT) managers) of the enterprise can access and manage user information stored in the EVNR 228 through an EFMC service center (ESC) 230. In one embodiment, the ESC 230 is a secured web server that provides interface and accessibility to enterprise personnel for enterprise user account management. As such, the ESC 230 can provide for remote access by enterprise personnel.

Various embodiments of the EFMC network 204 include an EFMC network operation and maintenance center (E-OMC) 232. The E-OMC 232 can be a server that provides operation and maintenance services to EFMC network 204 administrators.

With further regard to the PSTN 116, the EFMC network 204 checks calls from the PSTN 116 to determine if the calls from the PSTN 116 are directed to an enterprise voice number. The EFMC network 204 checks whether calls include an enterprise extension phone number (EEPN). Then the EFMC network 204 checks whether a registered mobile phone is associated with the EEPN. If so, both the associated mobile phone and the associated enterprise-based phone (e.g., office phone) are rung. As such, the user can answer either the mobile phone or the enterprise-based phone to handle calls from the PSTN 116 into the enterprise. If neither the mobile phone nor the enterprise-based phone is answered, the voicemail box can handle the call.

In accordance with various embodiments, the EFMC service enables transferring ongoing calls from a registered mobile phone to other registered mobile phones and/or enterprise-based phones. For example, a user may transfer a current call on the user's registered mobile phone to the user's enterprise-based phone, and vice versa. Such a transfer may be made by the user indicating the desired transfer, including a target EEPN, to the EMSC, and the EMSC responding by ringing the indicated EEPN.

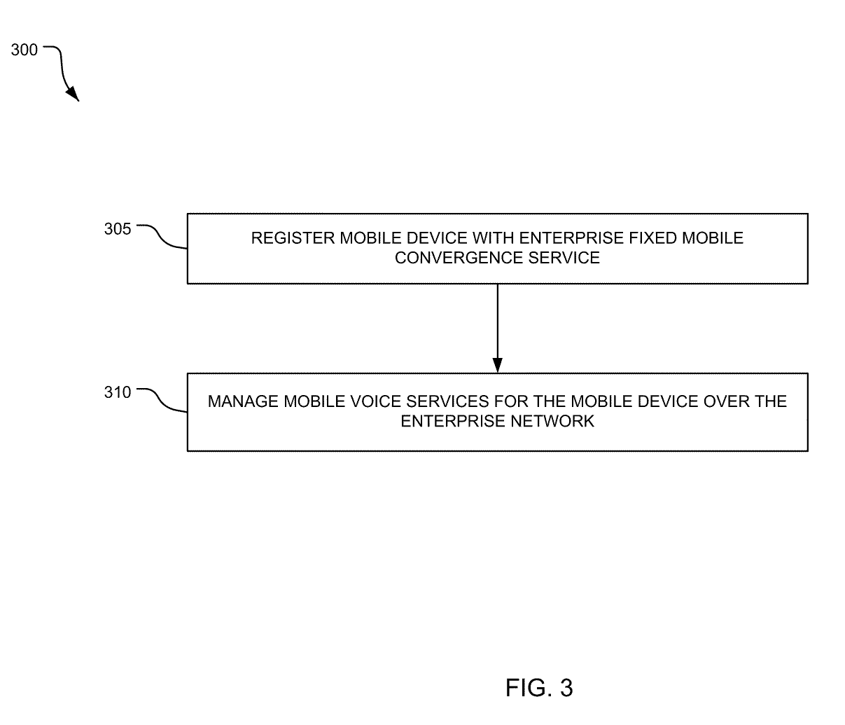

FIG. 3 is a flow diagram illustrating example operations related to enterprise fixed mobile convergence according to one embodiment. The various operations shown in the flow diagrams of FIGS. 3-5 may be carried out by one or more of the network components described above with respect to FIGS. 1-2. Furthermore, the operations shown in FIGS. 3-5 need not be performed in the order shown.

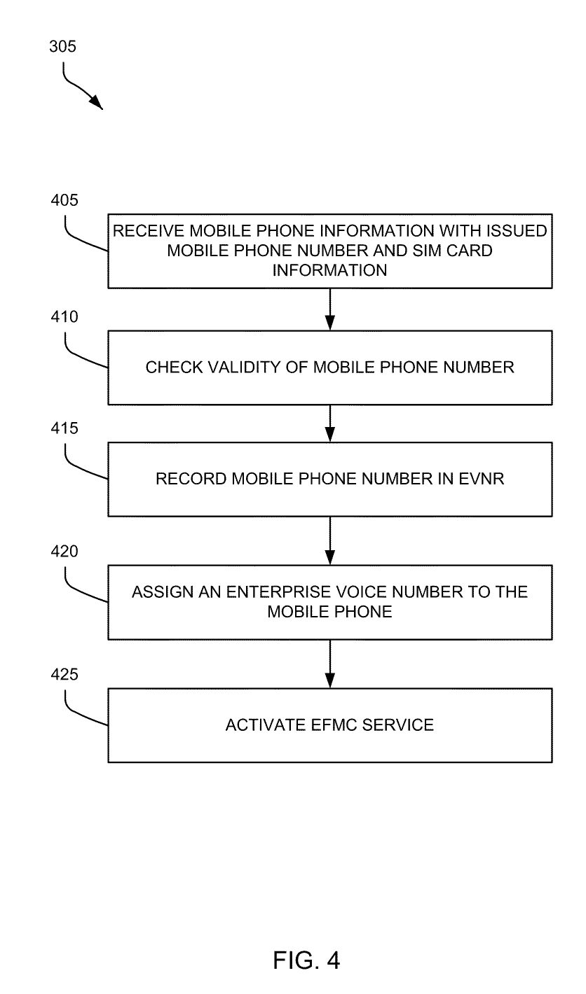

In a registering operation 305, a mobile device is registered with an enterprise fixed mobile convergence service. A mobile device that is registered with the enterprise fixed mobile convergence service can be managed according to enterprise fixed mobile convergence functions. A particular embodiment of the registering operation is shown in FIG. 4 and described further below.

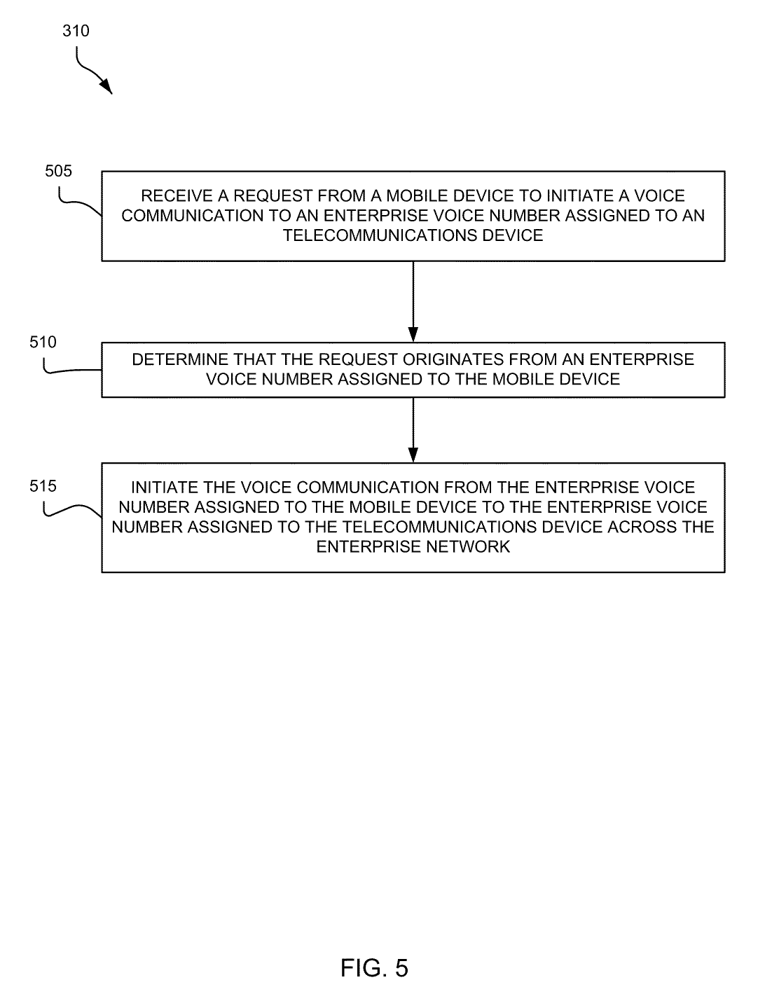

In a managing operation 310, mobile voice services are managed for the registered mobile device over the enterprise network. A particular embodiment of the managing operation 310 is shown in FIG. 5 and discussed further below.

Turning to FIG. 4, operations of an example registering process 305 are shown in a flow diagram. In a receiving operation 405, mobile phone information is received to register the mobile phone for enterprise fixed mobile convergence service. The mobile phone information identifies the phone and typically includes the mobile phone number issued by the mobile phone service provider and subscriber identification module (SIM) card information identifying the mobile phone service subscriber.

In a checking operation 410, the validity of the mobile phone number is checked. In one embodiment, a query is made to a database of valid mobile phone numbers maintained by the mobile phone service provider. Assuming the given mobile phone number is valid, in a recording operation 415 the mobile phone number is recorded in an enterprise voice number registry. In one embodiment, the EVNR is maintained on a registration server operable to store enterprise user information and service definitions and map mobile phone identification information to assigned enterprise voice numbers. In some embodiments, enterprise information technology (IT) personnel can access and manage the user information remotely.

In an assigning operation 420, an enterprise voice number is assigned to the mobile phone. The assigned enterprise voice number is a unique phone number accessible via the enterprise network. Accordingly, the assigned enterprise voice number is recognized on the enterprise network, and calls can be placed to or from the assigned enterprise voice number over the enterprise network. In one embodiment, the assigning operation 425 stores the assigned enterprise voice number in association with mobile phone identification information.

As a result of assigning operation 425, the mobile device has at least two associated numbers: a mobile phone number issued by the mobile service provider, and the enterprise voice number. Beneficially, the user of the mobile device can choose which number to give out to people associated with the user, based on whether the people are work associates or friends or family.

An activating operation 425 activates EFMC service with respect to the mobile phone. The activating operation 425 generally activates the assigned enterprise voice number for service over the enterprise network. In one embodiment, activating EFMC service involves setting an EFMC service indicator associated with the mobile phone that indicates the mobile phone is registered for EFMC service. EFMC service typically involves monitoring the registered mobile phone on the enterprise network to determine where the mobile phone is. In one embodiment, the locations of registered mobile phones are maintained in a database.

FIG. 5 is a flow diagram illustrating an example mobile voice services management process 310 for managing mobile voice services over an enterprise network according to an embodiment. A receiving operation 505 receives a request from a mobile device to initiate a voice communication to a telecommunications device assigned an enterprise voice number. In one embodiment, the receiving operation 505 receives the request from an enterprise location (e.g., proximate to an enterprise base station). In another embodiment, the receiving operation 505 receives the request from a backbone network, such as backbone network 106 (FIG. 1).

A determining operation 510 determines that the request to initiate the voice communication originated from an enterprise voice number assigned to the mobile device. In one embodiment of the determining operation 510, a database of assigned enterprise numbers (e.g., EVNR) is checked to determine whether the calling number is an enterprise voice number.

An initiating operation 515 initiates the voice communication from the mobile device to the called telecommunications device across the enterprise network, based at least in part on the determination that the calling number is an enterprise voice number assigned to the mobile device. By initiating the voice communication over the enterprise network, the voice communication is not routed over the mobile service provider carrier network. As such, any service charges associated with the mobile device for the voice communication are attributed to the enterprise network.

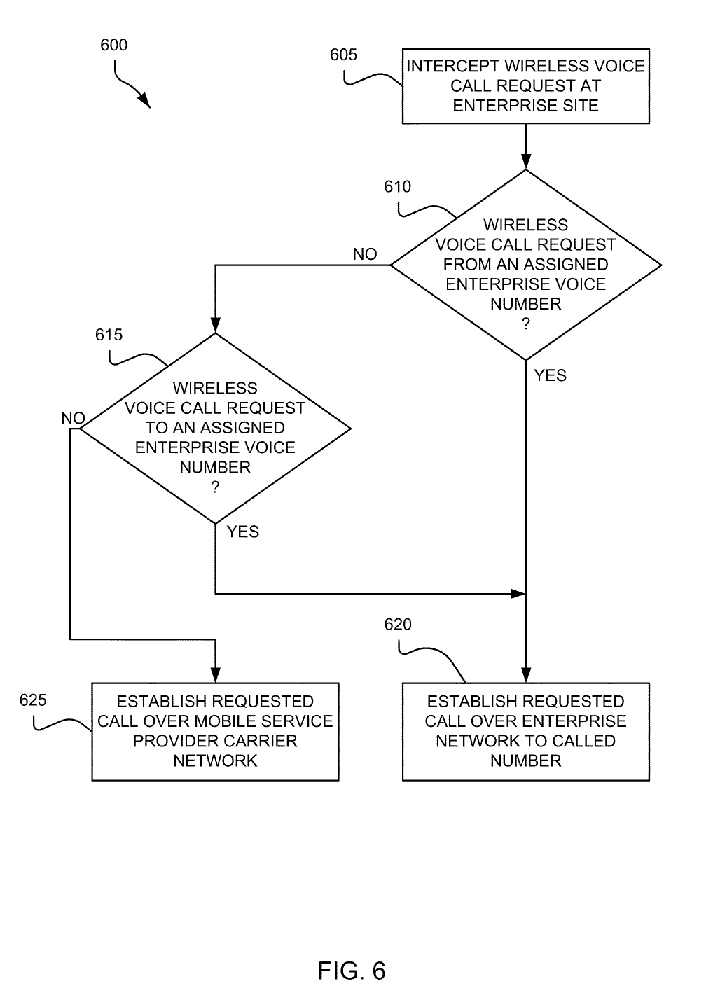

FIG. 6 is a flow diagram illustrating an alternative process 600 for managing mobile voice service in an enterprise network. In an intercepting operation 605, a wireless voice call request is intercepted at an enterprise site. In one embodiment, the intercepting operation involves an enterprise-based wireless base station proximate to the mobile device receiving a call request signal from the mobile device.

In a first query operation 610, it is determined whether the wireless voice call request originated from a mobile device that has been assigned an enterprise voice number. In one embodiment, query operation 610 queries a database (e.g., EVNR) to determine if the calling number associated with the call request is an assigned enterprise voice number. If so, the process branches “YES” to an establishing operation 620 where the call is established across an enterprise network. The call may be established within one site of an enterprise or from one site to another site (i.e., inter-site).

If the calling number is determined to not be an assigned enterprise voice number, the process 600 branches “NO” to another query operation 615, which determines whether the called number of the call request is an assigned enterprise voice number. In one embodiment, query operation 615 queries a database of assigned enterprise voice numbers to determine if the called number is an assigned enterprise voice number. If the called number is an assigned enterprise voice number, the process 600 branches “YES” to the establishing operation 620, in which the requested call is established across the enterprise network.

If neither the calling number nor the called number of the call request is an assigned enterprise voice number, the process 600 branches “NO” to another establishing operation 625, where the call is established across a network other than the enterprise network. In one embodiment, establishing operation 625 establishes the requested call across a mobile services provider carrier network associated with the mobile device that originated the call request.

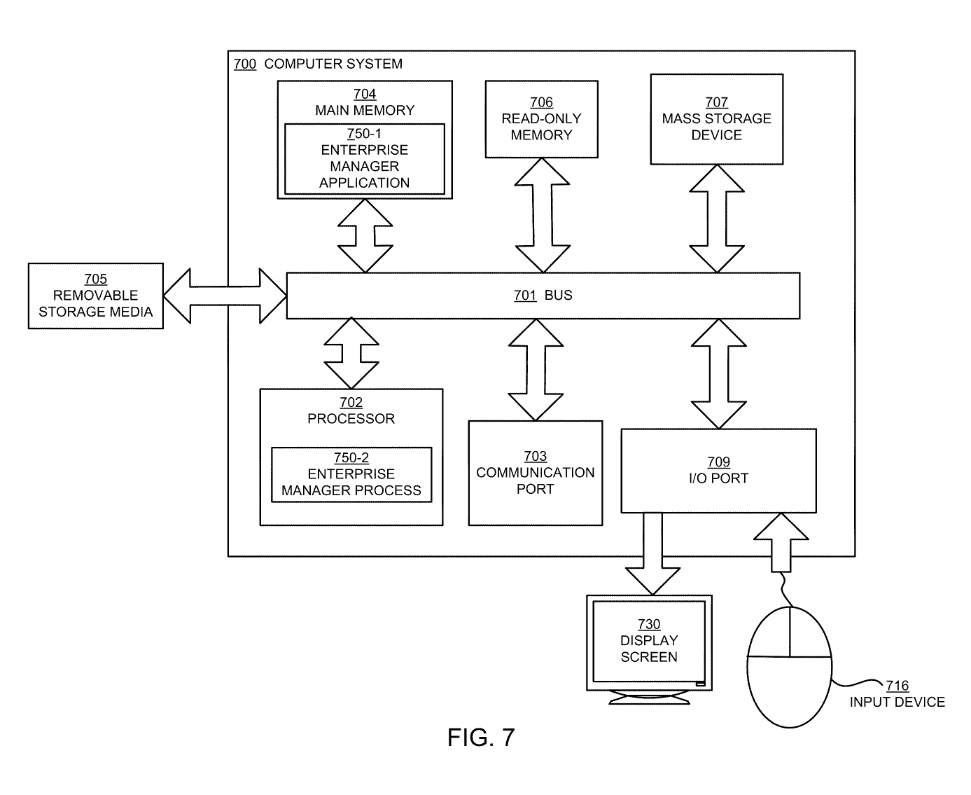

FIG. 7 is a schematic diagram of a computer system 700 upon which embodiments of the present invention may be implemented and carried out. For example, one or more computing devices 700 may be used to manage mobile enterprise voice service across an enterprise network.

According to the present example, the computer system 700 includes a bus 701 (i.e., interconnect), at least one processor 702, at least one communications port 703, a main memory 704, a removable storage media 705, a read-only memory 706, and a mass storage 707. Processor(s) 702 can be any known processor, such as, but not limited to, an Intel® Itanium® or Itanium 2® processor(s), AMD® Opteron® or Athlon MP® processor(s), or Motorola® lines of processors. Communications ports 703 can be any of an RS-232 port for use with a modem based dial-up connection, a 10/100 Ethernet port, a Gigabit port using copper or fiber, or a USB port. Communications port(s) 703 may be chosen depending on a network such as a Local Area Network (LAN), a Wide Area Network (WAN), or any network to which the computer system 700 connects. The computer system 700 may be in communication with peripheral devices (e.g., display screen 730, input device 716) via Input/Output (I/O) port 709.

Main memory 704 can be Random Access Memory (RAM), or any other dynamic storage device(s) commonly known in the art. Read-only memory 706 can be any static storage device(s) such as Programmable Read-Only Memory (PROM) chips for storing static information such as instructions for processor 702. Mass storage 707 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 701 communicatively couples processor(s) 702 with the other memory, storage and communications blocks. Bus 701 can be a PCI/PCI-X, SCSI, or Universal Serial Bus (USB) based system bus (or other) depending on the storage devices used. Removable storage media 705 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), etc.

Embodiments herein may be provided as a computer program product, which may include a machine-readable medium having stored thereon instructions, which may be used to program a computer (or other electronic devices) to perform a process. The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

As shown, main memory 704 is encoded with enterprise manager application 750-1 that supports functionality as discussed above and as discussed further below. Enterprise manager application 750-1 (and/or other resources as described herein) can be embodied as software code such as data and/or logic instructions (e.g., code stored in the memory or on another computer readable medium such as a disk) that supports processing functionality according to different embodiments described herein. During operation of one embodiment, processor(s) 702 accesses main memory 704 via the use of bus 701 in order to launch, run, execute, interpret or otherwise perform the logic instructions of the enterprise manager application 750-1. Execution of enterprise manager application 750-1 produces processing functionality in enterprise manager process 750-2. In other words, the enterprise manager process 750-2 represents one or more portions of the enterprise manager application 750-1 performing within or upon the processor(s) 702 in the computer system 700.

It should be noted that, in addition to the enterprise manager process 750-2 that carries out operations as discussed herein, other embodiments herein include the enterprise manager application 750-1 itself (i.e., the un-executed or non-performing logic instructions and/or data). The content enterprise manager 750-1 may be stored on a computer readable medium (e.g., a repository) such as a floppy disk, hard disk or in an optical medium. According to other embodiments, the enterprise manager application 750-1 can also be stored in a memory type system such as in firmware, read only memory (ROM), or, as in this example, as executable code within the main memory 704 (e.g., within Random Access Memory or RAM). For example, enterprise manager application 750-1 may also be stored in removable storage media 705, read-only memory 706, and/or mass storage device 707.

Example functionality supported by computer system 700 and, more particularly, functionality associated with enterprise manager application 750-1 and enterprise manager process 750-2 is discussed above with reference to FIGS. 3-6.

In addition to these embodiments, it should also be noted that other embodiments herein include the execution of the enterprise manager application 750-1 in processor(s) 702 as the enterprise manager process 750-2. Thus, those skilled in the art will understand that the computer system 700 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware.

Various modifications and additions can be made to the example embodiments discussed herein without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

What is claimed is:

1. A method for communicating in an enterprise network, the method comprising:
determining that a mobile device generating a communication request has an assigned enterprise voice number; and
based in part on determining that the mobile device has an assigned enterprise voice number, establishing the requested communication over the enterprise network.

2. The method of claim 1, wherein establishing the requested communication over the enterprise network comprises bypassing a mobile service provider network associated with the mobile device.

3. The method of claim 1, further comprising receiving the communication request proximate to an enterprise site.

4. The method of claim 3, wherein receiving the communication request comprises intercepting the communication request at a wireless base station at the enterprise site.

5. The method of claim 1, further comprising receiving the communication request from a backbone network.

6. The method of claim 1, wherein determining that the mobile device has an assigned enterprise voice number comprises querying a database of enterprise voice numbers assigned to mobile devices.

7. The method of claim 1, further comprising assigning the enterprise voice number to the mobile device.

8. The method of claim 7, further comprising validating that the mobile device has a mobile phone number issued by an associated mobile service provider.

9. The method of claim 1, wherein establishing the requested communication over the enterprise network causes service charges associated with the requested communication to be attributed to the enterprise network rather than the mobile service provider network associated with the mobile device.

10. A system for communicating over an enterprise network, the system comprising:
an enterprise voice number registry that maps enterprise voice numbers to mobile devices registered on the enterprise network;
an enterprise mobile switching center operable to query the enterprise voice number registry to determine if a mobile device is registered and further operable to determine that a communication requested by the mobile device should be established over the enterprise network based on the determination that the mobile device is registered.

11. The system of claim 10 further comprising a location registry operable to monitor the location of the mobile device in the enterprise.

12. The system of claim 10, wherein the enterprise mobile switching center is further operable to validate that a mobile device has a mobile phone number issued by an associated mobile service provider.

13. The system of claim 10, further comprising a remotely accessible interface operable to provide access to the enterprise voice number registry.

14. The system of claim 10, further comprising an enterprise media gateway in communication with an enterprise switch to enable communications between the enterprise switch and one or more of the Internet, a public landline mobile network and a public switched telephone network.

15. The system of claim 14, further comprising a base station controller in communication with the enterprise media gateway to manage wireless enterprise base stations operable to handle communications to and from registered mobile devices.

16. The system of claim 10, wherein establishing the requested communication over the enterprise network causes service charges associated with the requested communication to be attributed to the enterprise network.

17. A computer program product including a computer-readable media storing computer-executable instructions, which cause a computer to carry out a process comprising:
receiving a request to initiate a voice communication over an enterprise network to a first enterprise voice number assigned to a mobile device, the request initiated by a telecommunications device associated with the enterprise network, the telecommunications device having a second enterprise voice number assigned thereto;
determining that the request originates from the second enterprise voice number; and
initiating the voice communication from the second enterprise voice number to the first enterprise voice number across the enterprise network, wherein service charges associated with the mobile device for the voice communication are attributable to the enterprise network.

18. The computer program product of claim 17, wherein the process further comprises assigning the first enterprise voice number to the mobile device.

19. The computer program product of claim 18, wherein the process further comprises checking a registry of a public landline mobile network to validate a mobile phone number of the mobile device prior to assigning the first enterprise voice number to the mobile device.

20. The computer program product of claim 17, wherein the process further comprises monitoring the location of the mobile device within the enterprise network.
